(19) United States
(12) Patent Application Publication
(10) Pub. No.: US 2009/0266273 A1
(43) Pub. Date: Oct. 29, 2009

(54) PULVERULENT COMPOSITION COMPRISING A HYDRAULIC BINDER AND A PYROGENIC METAL OXIDE

(75) Inventors: Christoph Tontrup, Alzenau (DE); Brigitte Grinschgl, Rodgau (DE); Anne Heiseler, Seligenstadt (DE); Juergen Meyer, Stockstadt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GMBH, Essen (DE)

(21) Appl. No.: 12/299,395

(22) PCT Filed: Mar. 30, 2007
(86) PCT No.: PCT/EP2007/053099

§ 371 Date: Feb. 2, 2009

(30) Foreign Application Priority Data
May 5, 2006 (DE) 102006020880.3

(51) Int. Cl. C04B 7/00

(52) U.S. Cl. 106/816

(57) ABSTRACT

Pulverulent composition comprising at least one hydraulic binder having a d₅₀ value of the particle size distribution of <15 μm and at least one pyrogenic metal oxide in a proportion of 20 to 600 m² surface area/100 g of hydraulic binder. Use of the pulverulent composition for the production of products containing hydraulic binders.

The invention relates to a composition comprising a hydraulic binder and a pyrogenic metal oxide.

It is known that reactive fillers, such as, for example, microsilica or pyrogenic oxides, which have a pozzolanic reactivity and a filling effect and therefore result in an improvement in the contact zone between hardened cement base and aggregate can be used in concrete production. According to the prior art, these substances are added in concrete production separately from the binders in the form of powders or dispersions. It is furthermore known that hydraulic binders, in particular very finely divided cement, exhibit poor flow behaviour. Inexact, varying metering of the hydraulic binders may therefore occur in the production of a concrete, which may adversely affect the properties of fresh concrete and ready-mixed concrete.

Furthermore, very finely divided cement tends to cake: the atmospheric humidity causes the cement particles to undergo concretion. The more finely the cement is comminuted, the more pronounced is this effect since this specific surface area increases continuously. Caking eliminates the desired effect of an increase in the strength of concrete or mortar which was obtained by means of high-energy comminution of the raw material, since the caked surface is no longer available for the hydration reaction.

It was therefore a technical object of the invention to provide a form of administration of a hydraulic binder which permits problem-free metering thereof, avoids caking and at the same time positively influences the properties of the concrete or mortar produced.

The object is achieved by a pulverulent composition comprising at least one hydraulic binder having a d₅₀ value of the particle size distribution of <15 μm and at least one pyrogenic metal oxide in a proportion of 20 to 600 m² surface area/100 g of hydraulic binder.

The composition according to the invention exhibits, in the stated range of the pyrogenic metal oxide, substantially improved flowability which makes it possible to meter the composition exactly without adversely affecting the properties of a fresh concrete or fresh mortar obtained with the composition according to the invention.

Proportions of pyrogenic metal oxide of more than 600 m² surface area/100 g of hydraulic binder lead to an undesired thickening of the fresh concrete or fresh mortar. In the case of proportions of less than 20 m² surface area/100 g of hydraulic binder, the flowability is only insignificantly increased in comparison with a hydraulic binder which contains no pyrogenic metal oxide and/or the tendency to cake is only insignificantly reduced.

A hydraulic binder is to be understood as meaning a binder which hardens spontaneously with added water. These are, for example, cement and hydraulic lime. The composition according to the invention preferably contains cement.

The hydraulic binder can preferably be a very fine cement having a d₅₀ value of the particle size distribution of <10 μm and in particular d₅₀<7 μm.

A product containing hydraulic binders is to be understood as meaning a product which is cured as a result of the reaction of the hydraulic binder with water. These are, for example, concretes and mortars.

The product may also contain aggregates. Aggregates are inert substances which consist of unbroken or broken particles (e.g. stones, gravel) or of natural (e.g. sand) or synthetic mineral substances.

Accordingly, the products containing hydraulic binders include both the hardened hydraulic binder pastes (i.e. prepared from hydraulic binder and water without aggregates) and conglomerates (i.e. prepared from a mixture of hydraulic binder, aggregates and water).

Examples of conglomerates are hydraulic mortars (mixture of hydraulic binder, water and fine aggregates) and concretes (mixture of hydraulic binder, water and coarse and fine aggregates).

Pyrogenic is to be understood as meaning metal oxide particles obtained by flame oxidation and/or flame hydrolysis. Oxidizable and/or hydrolysable starting materials are as a rule oxidized or hydrolysed in a hydrogen/oxygen flame. Organic and inorganic substances may be used as starting materials for pyrogenic processes. For example, the readily available chlorides, such as silicon tetrachloride, aluminium chloride or titanium tetrachloride, are particularly suitable. Suitable organic starting compounds may be, for example, alcoholates, such as Si(OC₂H₅)₄, Al(OiC₃H₇)₃ or Ti(OiPr)₄. The metal oxide particles thus obtained are very substantially pore-free and have free hydroxyl groups on the surface. As a rule, the metal oxide particles are present at least partly in the form of aggregated primary particles. In the present invention, metalloid oxides, such as, for example, silica, are referred to as metal oxide.

The pyrogenic metal oxide present in the composition according to the invention preferably has a BET surface area of 20 to 400 m²/g.

The composition according to the invention can advantageously contain silica, titanium dioxide, alumina, zirconium dioxide, silicon-aluminium mixed oxide, silicon-titanium mixed oxide, titanium-aluminium mixed oxide and/or alkali metal-silica mixed oxide.

A composition according to the invention which contains silica, alumina or titanium dioxide is particularly preferred. In particular, the AEROSIL® and AEROXIDE® types, Degussa AG, mentioned in table 1, are suitable as pyrogenic metal oxides.

Furthermore, the following types can be used: CAB-O-SIL™ LM-150, LM-150D, M-5, M-5P, M-5DP, M-7D, PTG, HP-60; SpectrAl™ 51, 81, 100; all from Cabot Corp.; HDK® S13, V15, V15P, N20, N20P, all Wacker; REOLOSIL™ QS-10, QS-20, QS-30, QS-40, DM-10, all from Tokuyama.

The pyrogenic metal oxides may also be present in surface-modified form. For this purpose, it is possible to use the following silanes, individually or as a mixture:

Organosilanes (RO)₃Si(CₙH₂ₙ₊₁) and (RO)₃Si(CₙH₂ₙ₋₁)

where R=alkyl, such as methyl, ethyl, n-propyl, isopropyl or butyl and n=1-20.

Organosilanes R′ₓ(RO)_{y}Si(CₙH₂ₙ₊₁) and R′ₓ(RO)_{y}Si(CₙH₂ₙ₋₁)

where R=alkyl, such as methyl, ethyl, n-propyl, isopropyl or butyl; R′=alkyl, such as methyl, ethyl, n-propyl, isopropyl or butyl; R′=cycloalkyl; n=1-20; x+y=3, x=1, 2; y=1, 2.

TABLE 1
Metal oxides suitable for the composition according to the invention

| | BET | | |
|---|---|---|---|
| | surface | Loss on | |
| | area | drying | |
| Type | [m²/g] | [% by wt.] | pH |
| AEROSIL ®(SiO₂) | | | |
| 90 | 90 ± 15 | ≦1.0 | 3.7-4.7 |
| 130 | 130 ± 25 | ≦1.5 | 3.7-4.7 |
| 150 | 150 ± 15 | ≦0.5 | 3.7-4.7 |
| 200 | 200 ± 25 | ≦1.5 | 3.7-4.7 |
| 300 | 300 ± 30 | ≦1.5 | 3.7-4.7 |
| 380 | 380 ± 30 | ≦2.0 | 3.7-4.7 |
| 50 | 50 ± 15 | ≦1.5 | 3.8-4.8 |
| TT 600 | 200 ± 50 | ≦2.5 | 3.6-4.5 |
| OX50 | 50 ± 15 | ≦1.0 | 3.8-4.8 |
| MOX 80* | 80 ± 20 | ≦1.5 | 3.6-4.5 |
| MOX 170* | 170 ± 30 | ≦1.5 | 3.6-4.5 |
| AEROXIDE ® | | | |
| TiO₂ P25 | 50 ± 15 | ≦1.5 | 3.5-4.5 |
| Alu C (Al₂O₃) | 100 ± 15 | ≦5.0 | 4.5-5.5 |

*SiO₂/Al₂O₃

Haloorganosilanes X₃Si (CₙH₂ₙ₊₁) and X₃Si(CₙH₂ₙ₋₁)

where X=Cl, Br; n=1-20.

Haloorganosilanes X₂(R′)Si(CₙH₂ₙ₊₁) and X₂(R′)Si(CₙH₂ₙ₋₁)

where X=Cl, Br, R′=alkyl, such as methyl, ethyl, n-propyl, isopropyl or butyl; R′=cycloalkyl; n=1-20

Haloorganosilanes X(R′)₂Si(CₙH₂ₙ₊₁) and X(R′)₂Si(CₙH₂ₙ₋₁)

where X=Cl, Br; R′=alkyl, such as methyl, ethyl, n-propyl, isopropyl or butyl-; R′=cycloalkyl; n=1-20

Organosilanes (RO)₃Si(CH₂)ₘ—R′

where R=alkyl, such as methyl, ethyl or propyl; m=0, 1-20; R′=methyl, aryl such as —C₆H₅, substituted phenyl radicals, C₄F₉, OCF₂—CHF—CF₃, C₆F₁₃, OCF₂CHF₂, NH₂, N₃, SCN, CH═CH₂, NH—CH₂—CH₂—NH₂, N—(CH₂—CH₂—NH₂)₂, OOC(CH₃)C═CH₂, OCH₂—CH(O)CH₂, NH—CO—N—CO—(CH₂)₅, NH—COO—CH₃, NH—COO—CH₂—CH₃, NH—(CH₂)₃Si(OR)₃, Sₓ—(CH₂)₃Si(OR)₃, SH, NR′R″R′″ where R′=alkyl, aryl; R″=H, alkyl, aryl; R′″=H, alkyl, aryl, benzyl, C₂H₄NR″″R′″″ where R″″=H, alkyl and R′″″=H, alkyl.

Organosilanes (R″)ₓ(RO)_{y}Si(CH₂)ₘ—R′

where R″=alkyl, x+y=3; cycloalkyl, x=1, 2, y=1, 2; m=0, 1 to 20; R′=methyl, aryl, such as C₆H₅, substituted phenyl radicals, C₄F₉, OCF₂—CHF—CF₃, C₆F₁₃, OCF₂CHF₂, NH₂, N₃, SCN, CH═CH₂, NH—CH₂—CH₂—NH₂, N—(CH₂—CH₂—NH₂)₂, OOC(CH₃)C═CH₂, OCH₂—CH(O)CH₂, NH—CO—N—CO—(CH₂)₅, NH—COO—CH₃, NH—COO—CH₂—CH₃, NH—(CH₂)₃Si(OR)₃, Sₓ—(CH₂)₃Si(OR)₃, SH, NR′R″R′″ where R′=alkyl, aryl; R″=H, alkyl, aryl; R′″=H, alkyl, aryl, benzyl, C₂H₄NR″″R′″″ where R″″=H, alkyl and R′″″=H, alkyl.

Haloorganosilanes X₃Si(CH₂)ₘ—R′

X=Cl, Br; m=0, 1-20; R′=methyl, aryl, such as C₆H₅, substituted phenyl radicals, C₄F₉, OCF₂—CHF—CF₃, C₆F₁₃, O—CF₂—CHF₂, NH₂, N₃, SCN, CH═CH₂, NH—CH₂—CH₂—NH₂, N—(CH₂—CH₂—NH₂)₂, —OOC(CH₃)C═CH₂, OCH₂—CH(O)CH₂, NH—CO—N—CO—(CH₂)₅, NH—COO—CH₃, —NH—COO—CH₂—CH₃, —NH—(CH₂)₃Si (OR)₃, —Sₓ—(CH₂)₃Si(OR)₃, where R=methyl, ethyl, propyl or butyl and x=1 or 2, SH.

Haloorganosilanes RX₂Si (CH₂)ₘR′

X=Cl, Br; m=0, 1-20; R′=methyl, aryl, such as C₆H₅, substituted phenyl radicals, C₄F₉, OCF₂—CHF—CF₃, C₆F₁₃, O—CF₂—CHF₂, NH₂, N₃, SCN, CH═CH₂, NH—CH₂—CH₂—NH₂, N—(CH₂—CH₂—NH₂)₂, OOC(CH₃)C═CH₂, OCH₂—CH(O)CH₂, NH—CO—N—CO—(CH₂)₅, NH—COO—CH₃, —NH—COO—CH₂—CH₃, —NH—(CH₂)₃Si(OR)₃, —Sₓ—(CH₂)₃Si(OR)₃, where R=methyl, ethyl, propyl or butyl and x=1 or 2, SH.

Haloorganosilanes R₂XSi(CH₂)ₘR′

X=Cl, Br; m=0, 1-20; R′=methyl, aryl, such as C₆H₅, substituted phenyl radicals, C₄F₉, OCF₂—CHF—CF₃, C₆F₁₃, O—CF₂—CHF₂, NH₂, N₃, SCN, CH═CH₂, NH—CH₂—CH₂—NH₂, N—(CH₂—CH₂—NH₂)₂, —OOC(CH₃)C═CH₂, OCH₂—CH(O)CH₂, NH—CO—N—CO—(CH₂)₅, NH—COO—CH₃, —NH—COO—CH₂—CH₃, —NH—(CH₂)₃Si(OR)₃, —Sₓ—(CH₂)₃Si(OR)₃, where R=methyl, ethyl, propyl or butyl and x=1 or 2, SH.

Silazanes R′R₂SiNHSiR₂R′ where R,R′=alkyl, vinyl, aryl.

Cyclic polysiloxanes D3, D4, D5

where D3, D4 and D5 are understood as meaning cyclic polysiloxanes having 3, 4 or 5 units of the type —O—Si(CH₃)₂, e.g. octamethylcyclotetrasiloxane=D4

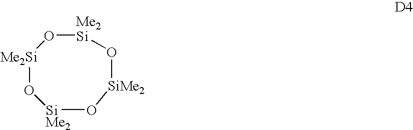

Polysiloxanes or silicone oils of the type

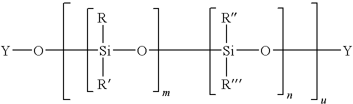

where
R=alkyl, aryl, (CH₂)ₙ—NH₂, H
R′=alkyl, aryl, (CH₂)ₙ—NH₂, H
R″=alkyl, aryl, (CH₂)ₙ—NH₂, H
R′″=alkyl, aryl, (CH₂)ₙ—NH₂, H
Y═CH₃, H, C_{z}H_{2z+1} where z=1-20,
Si(CH₃)₃, Si(CH₃)₂H, Si(CH₃)₂OH, Si(CH₃)₂(OCH₃), Si(CH₃)₂(C_{z}H_{2z+1})
   where
   R′ or R″ or R′″ is (CH₂)_{z}—NH₂ and
   z=1-20,
   m=0, 1, 2, 3, . . . ∞,
   n=0, 1, 2, 3, . . . ∞,
   u=0, 1, 2, 3, . . . ∞.

The following substances can preferably be used as surface modifiers: octyltrimethoxysilane, octyltriethoxysilane, hexamethyldisilazane, 3-methacryloyloxypropyltrimethoxysilane, 3-methacryloyloxypropyltriethoxysilane, hexadecyltrimethoxysilane, hexadecyltriethoxysilane, dimethylpolysiloxane, glycidyloxypropyltrimethoxysilane, glycidyloxypropyltriethoxysilane, nonafluorohexyltrimethoxysilane, tridecafluorooctyltrimethoxysilane, tridecafluorooctyltriethoxysilane, aminopropyltriethoxysilane.

Octyltrimethoxysilane, octyltriethoxysilane and dimethylpolysiloxane can particularly preferably be used.

Suitable surface-modified metal oxides can be selected, for example, from the AEROSIL® and AEROXIDE® types mentioned in table 2.

Furthermore, structurally modified metal oxides, as disclosed, for example, in EP-A-1199336, DE-A-10239423, DE-A-10239424 or WO2005095525, can be used.

The pyrogenic metal oxide present in the composition according to the invention is as a rule introduced as a powder. However, it is also possible to introduce the pyrogenic metal oxide in the form of a dispersion. Such dispersions are preferably highly filled dispersions having a content of at least 30% by weight, based on the dispersion.

Furthermore, it is advantageous if the moisture content of the pulverulent composition increases by not more than 5% and particularly preferably not more than 1.5% in comparison with the moisture content of the composition before the dispersion was sprayed on. Thus, for example, the hydraulic binder may have a moisture content of 2% before spraying on and one of not more than 7% and particularly preferably not more than 3.5% after spraying on. The small increase in the moisture content ensures that the composition is also present in powder form after spraying on. The spraying on can be effected by methods known to the person skilled in the art, by means of atomization of aqueous dispersions.

TABLE 2
Surface-modified metal oxides suitable for
the composition according to the invention

| | BET | | | |
|---|---|---|---|---|
| | surface | Loss on | | Carbon |
| | area | drying | | content |
| Type | [m²/g] | [% by wt.] | pH | [% by wt] |
| AEROSIL ® | | | | |
| R 972 | 110 ± 20 | ≦0.5 | 3.6-4.4 | 0.6-1.2 |
| R 974 | 170 ± 20 | ≦0.5 | 3.7-4.7 | 0.7-1.3 |
| R 104 | 150 ± 25 | — | ≧4.0 | 1.0-2.0 |
| R 106 | 250 ± 30 | — | ≧3.7 | 1.5-3.0 |
| R 202 | 100 ± 20 | ≦0.5 | 4.0-6.0 | 3.5-5.0 |
| R 805 | 150 ± 25 | ≦0.5 | 3.5-5.5 | 4.5-6.5 |
| R 812 | 260 ± 30 | ≦0.5 | 5.5-7.5 | 2.0-3.0 |
| R 816 | 190 ± 20 | ≦1.0 | 4.0-5.5 | 0.9-1.8 |
| R 7200 | 150 ± 25 | ≦1.5 | 4.0-6.0 | 4.5-6.5 |
| R 8200 | 160 ± 25 | ≦0.5 | ≧5.0 | 2.0-4.0 |
| R 9200 | 170 ± 20 | ≦1.5 | 3.0-5.0 | 0.7-1.3 |
| AEROXIDE ® | | | | |
| TiO₂ T805 | 45 ± 10 | — | 3.0-4.0 | 2.7-3.7 |
| TiO₂ NKT90 | 50-75 | — | 3.0-4.0 | 2.0-4.0 |
| Alu C 805 | 100 ± 15 | — | 3.0-5.0 | — |

The introduction of the dispersion can preferably be effected by spraying on in the form of fine droplets. As a result, caking of the hydraulic binder can be very substantially prevented.

A preferred composition according to the invention may be one which contains 40 to 400 m² surface area/100 g of cement, in particular 60 to 300 m² surface area/100 g of cement, a pyrogenic silica having a BET surface area of 90 to 300 m²/g and very fine cement having a d₅₀ value of the particle size distribution of <10 μm and in particular d₅₀<7 μm.

Furthermore, a preferred composition according to the invention may be one which contains 20 to 200 m² surface area/100 g of cement, in particular 25 to 100 m² surface area/100 g of cement, a pyrogenic titanium dioxide having a BET surface area of 40 to 100 m²/g and very fine cement having a d₅₀ value of the particle size distribution of <10 μm and in particular d₅₀<7 μm.

Furthermore, a particularly preferred composition according to the invention may be one which contains 40 to 600 m² surface area/100 g of cement, in particular 100 to 300 m² surface area/100 g of cement, a hydrophobized pyrogenic silica having a BET surface area of 100 to 300 m²/g and very fine cement having a d₅₀ value of the particle size distribution of <10 μm and in particular d₅₀<7 μm.

The invention furthermore relates to the use of the composition according to the invention for the production of products containing hydraulic binders, such as concretes and mortars.

### EXAMPLES

Production of a very fine cement: The very fine cement is produced on the basis of Zoz H. et al. (Cement, Lime, Gypsum, vol. 57, pages 60-70, 2004). The high-energy ball mill (Zoz-Simloyer CM 05) with steel balls is used. The rotor speed is 550 rpm and the milling time is 15 min. The starting material used is a standard cement (CEM I 32, 5 R). The particle size distribution of the cement is determined using a conventional laser diffraction measuring apparatus (Horiba LA-920) in isopropanol. For the measurement, the sample is treated with the integral ultrasound for a duration of 2 min in order to disperse loose agglomerates of the cement particles. The median value of the particle size distribution (d₅₀ value) is used as a criterion for the comminution of the cement. Said value was 18 μm in the case of the starting material and 6 μm in the case of the milled very fine cement.

### Example 1

### Flow Behaviour

The very fine cement and the pyrogenic metal oxide powder are mixed for 5 min in a Somakon mixer at 1000 rpm. Thereafter, it is determined whether or not the mixture flows out of a specific glass efflux vessel (use of glass efflux vessels for determining the flow behaviour is described in publication series Pigmente [Pigments] No. 31, Degussa AG). The glass efflux vessel is simulated by a round hopper having a conical outlet: total height of the vessel is 80 mm, cone height 12.8 mm, internal diameter of cylindrical part 36.5 mm, internal diameter of outflow opening 24 mm. The glass efflux vessel is filled to the brim with sample material and allowed to stand for 10 s in order to ensure that the powder settles. Thereafter, the vessel is raised and the outlet is thus opened. Whether or not the sample material flows out of the vessel is then noted.

Table 3 shows the influence of different amounts of pyrogenic metal oxide powder on the flow behaviour of the very fine cement produced above.

The very fine cement without addition of pyrogenic metal oxide powder does not flow out of the glass vessel, which shows that it is only poorly meterable.

Table 3 shows that very fine cement can be caused to flow by addition of pyrogenic metal oxide powders if the proportion thereof is greater than 20 m² surface area/100 g of hydraulic binder.

TABLE 3
Flow behaviour in the presence of pyrogenic SiO₂

| 200^{$)} | | R972^{$)} | | R812^{$)} | |
|---|---|---|---|---|---|
| Amount*⁾ | Flowable | Amount*⁾ | Flowable | Amount*⁾ | Flowable |
| 0 | No | 0 | No | 0 | No |
| 40 | No | 11 | No | 52 | Yes |
| 100 | Yes | 16 | No | 130 | Yes |
| 200 | Yes | 55 | Yes | 260 | Yes |
| 300 | Yes | 110 | Yes | 420 | Yes |
| 400 | Yes | — | — | — | — |
| 800 | Yes | — | — | — | — |

^{$)}AEROSIL ®, Degussa AG;
*⁾m² surface area/100 g of cement

### Example 2

### Caking of Very Fine Cement

The tendency of pulverulent product to cake on stacking in bags or in a bin can be determined by measuring the compressive strength (publication series Pigmente [Pigments] No. 31, Degussa AG). The powder to be assessed is introduced into a steel cylinder having an internal diameter of 50 mm, for example to a height of 20 mm, and loaded with a ram which has a weight of 1.2 kg and fits exactly into the steel cylinder. The material is then stored for 4 days at 20° C. and about 60% relative humidity. After the 4 days, the cylinder is removed and the tablet thus formed is assessed according to table 4.

The cement without pyrogenic silica was rated with the rating 6, i.e. a firm tablet formed. This means that such a cement has a very strong tendency to cake. Table 5 shows that at least adequate ratings can be achieved by addition of pyrogenic silica if an appropriate amount is added. The samples are only loosely caked and disintegrate into very fine material under pressure from finger. In the case of compositions according to the invention with at least adequate rating, it is ensured that the shear forces occurring during the production of the fresh concrete are sufficient for completely dispersing the cement. Only in this case can the potential of the very fine cement for the formation of high strength be fully utilized. At ratings of 5 and 6, this is not the case: a part of the comminution is eliminated by caking during storage. Furthermore, examples with Aerosil® 200 and Aerosil® R972 in table 5 show that the caking of the hydraulic binder cannot always be further reduced by larger and larger amounts of pyrogenic metal oxides. Caking properties which are rated with the rating “3” (on addition of Aerosil® R812) are also often not necessary at all in practice and smaller additions would lead to a more economical solution of the problem. Depending on the type of hydraulic binder and of pyrogenic metal oxide, there is therefore an optimum between the desired reduction of the tendency to cake and an undesired increase in the raw material costs for the pulverulent composition. Furthermore, larger amounts of pyrogenic metal oxide lead to an undesired thickening of the fresh concrete.

TABLE 4
Evaluation of the compressive strength

| | |
|---|---|
| 1 = very good | Completely unchanged and flowing |
| | smoothly through the efflux vessel |
| 2 = good | Partly loosely adhering; disintegrating |
| | easily into the original state |
| 3 = on the | Loosely formed; disintegrating very |
| whole good | substantially into pulverulent form on |
| | light pressure from a finger |
| 4 = adequate | Loosely caked; disintegrating into very |
| | fine form on testing with a finger |
| 5 = poor | Caked semisolid; no longer |
| | disintegrating into very fine form on |
| | testing with a finger. |
| 6 = inadequate | Firm |

TABLE 5
Compressive strength in the presence of pyrogenic SiO₂

| 200^{$)} | | R972^{$)} | | R812^{$)} | |
|---|---|---|---|---|---|
| Amount*⁾ | Rating | Amount*⁾ | Rating | Amount*⁾ | Rating |
| 0 | 6 | 0 | 6 | 0 | 6 |
| 40 | 5 | 11 | 6 | 26 | 5 |
| 100 | 4-5 | 22 | 5 | 52 | 5 |
| 200 | 4-5 | 55 | 4-5 | 130 | 4 |
| 300 | 4 | 110 | 4-5 | 260 | 3-4 |
| 400 | 4 | — | — | 520 | 3 |
| 800 | 4-5 | — | — | — | — |

^{$)}AEROSIL ®, Degussa AG;
*⁾m² surface area/100 g of cement

### Example 3

### Poured Cone Heights of Pulverulent Compositions

A further measure of the flowability is the determination of the poured cone height (description in publication series Pigmente [Pigments] No. 31, Degussa AG). A poured cone forms as a result of pouring out bulk material onto a cylinder. The height of the powder cone in mm is stated. Small numerical values correspond to good flowability. The method is very similar to the determination of the angle of repose according to DIN 4324, or the angle at the base of the cone, which is obtained by outflow of bulk material under stipulated conditions, is determined. Table 6 shows that a substantially lower poured cone height and hence substantially improved flowability is achieved by addition of Aerosil® R812 to the very fine cement.

TABLE 6
Poured cone height

| Added amount of | Poured cone |
|---|---|
| Aerosil ® R812 | height |
| m²/100 g | mm |
| 0 | >50 |
| 130 | 31 |
| 260 | 24 |
| 520 | 22 |

Evaluation: <20: very good; 21-30: good; 31-40: just adequate; 41-50: poor; >50: inadequate

1. A pulverulent composition comprising at least one hydraulic binder having a d₅₀ value of the particle size distribution of <15 μm and at least one pyrogenic metal oxide in a proportion of 20 to 600 m² surface area/100 g of hydraulic binder.

2. The pulverulent composition according to claim 1, characterized in that the hydraulic binder is a very fine cement having d₅₀<10 μm.

3. The pulverulent composition according to claim 1, characterized in that the BET surface area of the pyrogenic metal oxide is 20 to 400 m²/g.

4. The pulverulent composition according to claim 1, characterized in that the pyrogenic metal oxide is present in surface-modified form.

5. The pulverulent composition according to claim 1, characterized in that the pyrogenic metal oxide is selected from silica, titanium dioxide, alumina, zirconium dioxide, silicon-aluminium mixed oxide, silicon-titanium mixed oxide, titanium-aluminium mixed oxide and/or alkali metal-silica mixed oxide.

6. A method of using the pulverulent composition according to claim 1 for the production of products containing hydraulic binders.
